(19) United States
(12) Patent Application Publication
(10) Pub. No.: US 2004/0068838 A1
(43) Pub. Date: Apr. 15, 2004

(54) Handle for a suitcase

(76) Inventor: Bi-Hua Tsai, Taichung City (TW)

Correspondence Address: Charles E. Baxley, Hart, Baxley, Daniels & Holton, Fifth Floor, 59 John Street, New York, NY, 10038, US

(21) Appl. No.: 10/270,900

(22) Filed: Oct. 15, 2002

(51) Int. Cl. E05B 1/00

(52) U.S. Cl. 16/114.1

(57) ABSTRACT

A handle for a suitcase includes an inner member composed of a plurality of units which are rotatably connected with each other in an axial direction thereof. A flexible fabric wraps the inner member and two ends of the flexible fabric are fixed to the suitcase. An outer casing has a passage defined longitudinally therethrough and the inner member and the flexible fabric are received in the passage.

### FIELD OF THE INVENTION

The present invention relates to a handle for a suitcase or the like and includes an inner member wrapped by a fabric and both are received in a casing of the handle. The inner member is consisted of a plurality of units which are rotatably connected head-to-tail.

### BACKGROUND OF THE INVENTION

A conventional handle for a suitcase generally is a solid handle which is pivotably or fixedly connected to the suitcase by rivets. The solid handle usually has a fixed contour which is made by molding method and is designed for a hand that has a certain range of size. The handle is not comfortably grasped by those users who has small hands. Besides, because the solid handle is not deformed according to the user's hand so that no matter how heavy the load of the suitcase is, the user's had has to adapt the contour of the handle without options.

The present invention intends to provide a handle of a suitcase and the handle includes a flexible inner member which is composed of a plurality of rotatable units so that the hand automatically matches with the handle when grasping the handle.

### SUMMARY OF THE INVENTION

In accordance with one aspect of the present invention, there is provided a handle for a suitcase and the handle comprises an inner member which is composed of a plurality of units which are rotatably connected with each other in an axial direction thereof. A flexible fabric wraps the inner member and two ends of the flexible fabric are fixed to the suitcase. An outer casing has a passage defined longitudinally therethrough and the inner member and the flexible fabric are received in the passage.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the handle of the present invention;

FIG. 2 is a cross sectional view to show a hand grasping the handle of the present invention;

FIG. 3 is a cross sectional view to show that the suitcase is heavy and the hand grasping the handle of the present invention;

FIG. 4 is an exploded view to show another embodiment of the handle of the present invention, and

FIG. 5 shows yet another embodiment of the handle of the present invention.

### DETAILED DESCRIPTION OF THE PREFERRED EMBODIMENT

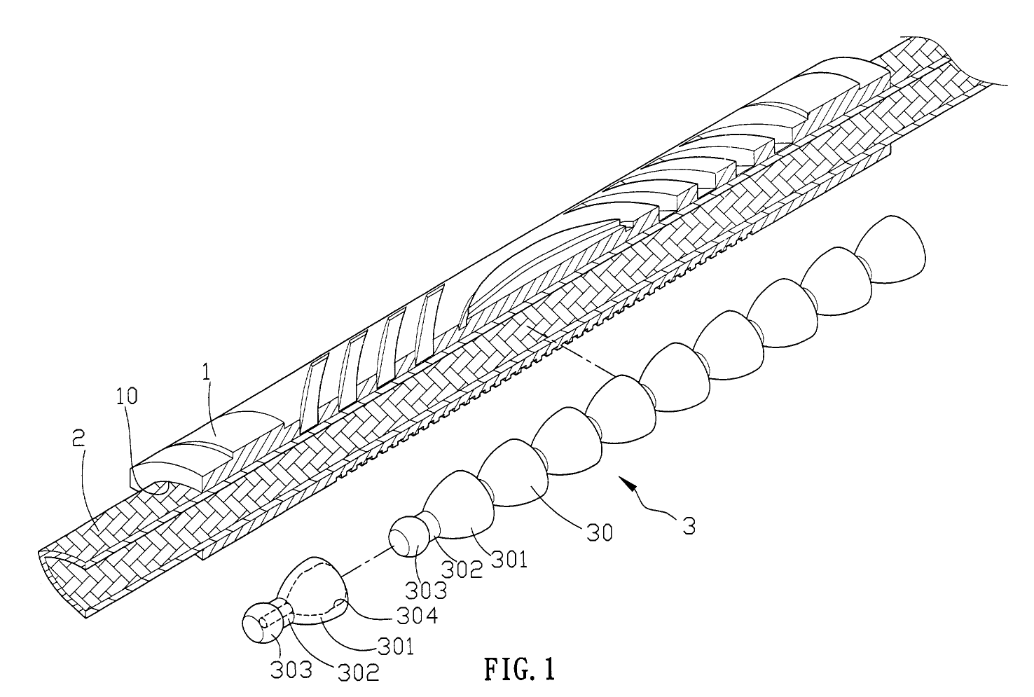

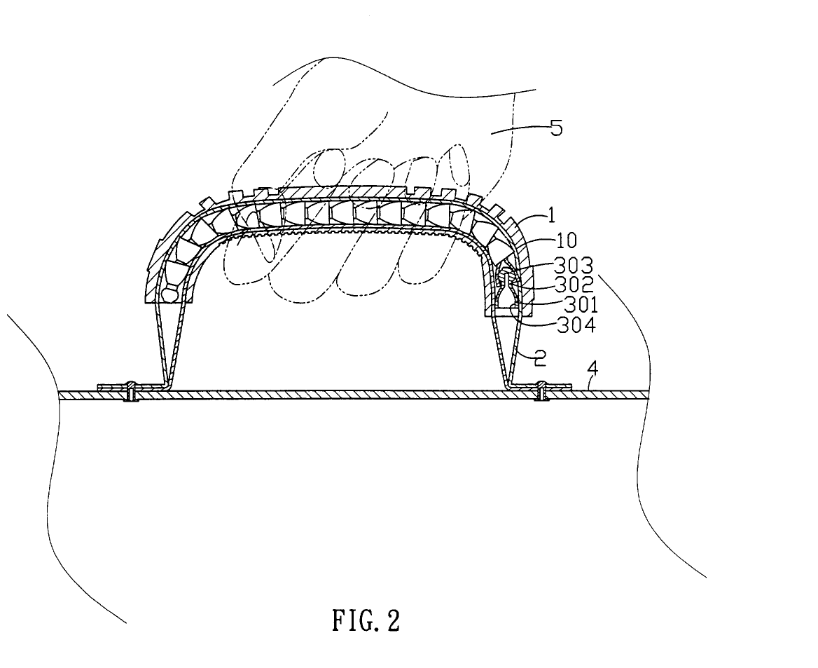

Referring to FIGS. 1 and 2, the handle of the present invention comprises an inner member 3 which is composed of a plurality of units 30 which are rotatably connected with each other in an axial direction thereof. Each unit 30 includes a tail 301, a neck 302 and a head 303, wherein the neck 302 is connected between the head 303 and the tail 301. The tail 301 is larger than the head 303. A recess 304 is defined in the tail 301 and opens to a distal end of the tail 301 in which the head 303 of next unit 30 is rotatably engaged.

A flexible fabric 2 wraps the inner member 3 and two ends of the flexible fabric 2 are fixed to the suitcase 4 by rivets. An outer casing 1 made of flexible material has a passage 10 defined longitudinally therethrough and the inner member 3 and the flexible fabric 2 are received in the passage 10.

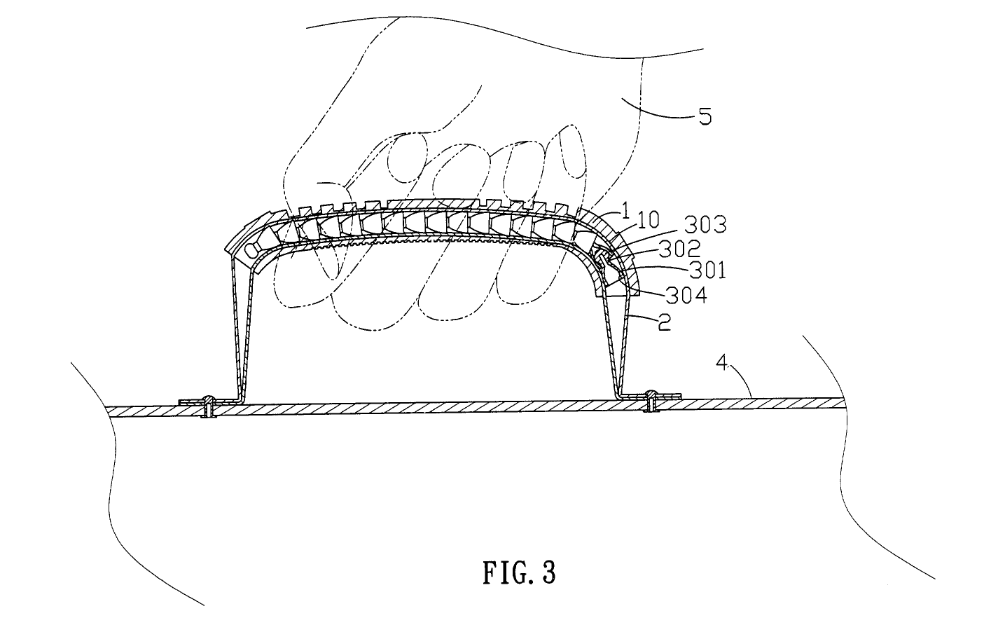

When a hand 5 grasps the handle, the rotatable units 30 are rotated by the force that is applied to them and the units 30 automatically are positioned at a position that matches with the hand 5 so that the hand is comfortable when holding the suitcase 4. As shown in FIG. 3, when the load of the suitcase 4 is heavy, the inner member 3 and the flexible outer casing 1 are deformed according to the load and snugly match the hand 5.

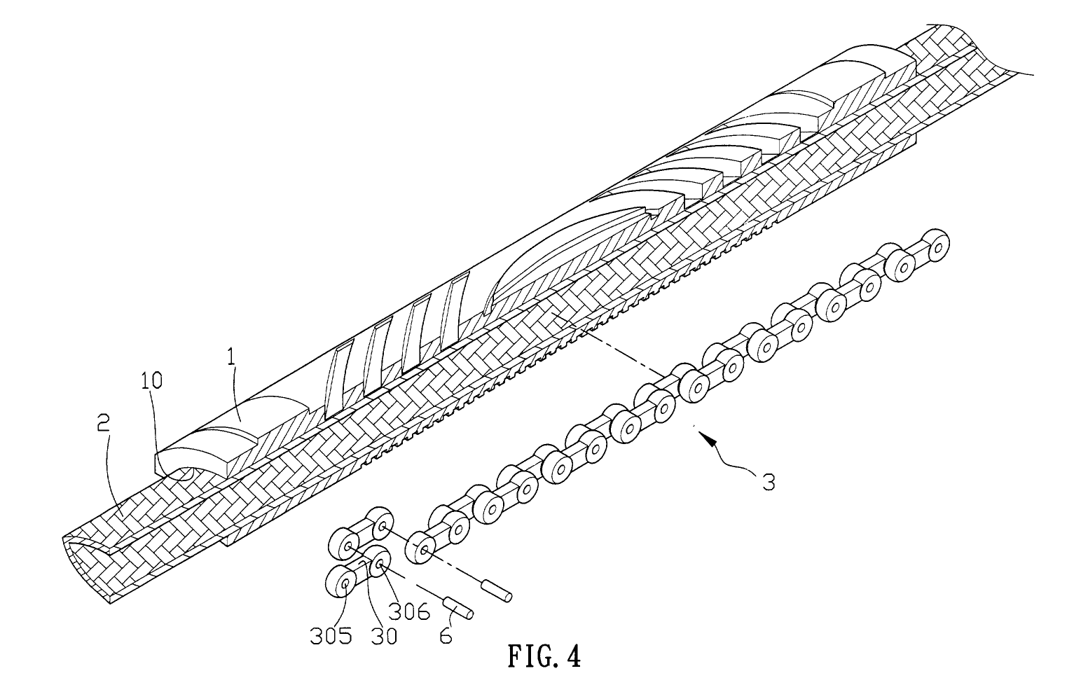

FIG. 4 shows another embodiment of the handle of the present invention, wherein each unit 30 has two holes 305, 306 respectively and radially defined through two ends thereof and a pin 6 extends through two aligned holes of two respective overlapped ends of two adjacent units 30. Therefore, the units 30 are pivotably connected with each other in alternative fashion by pins 6.

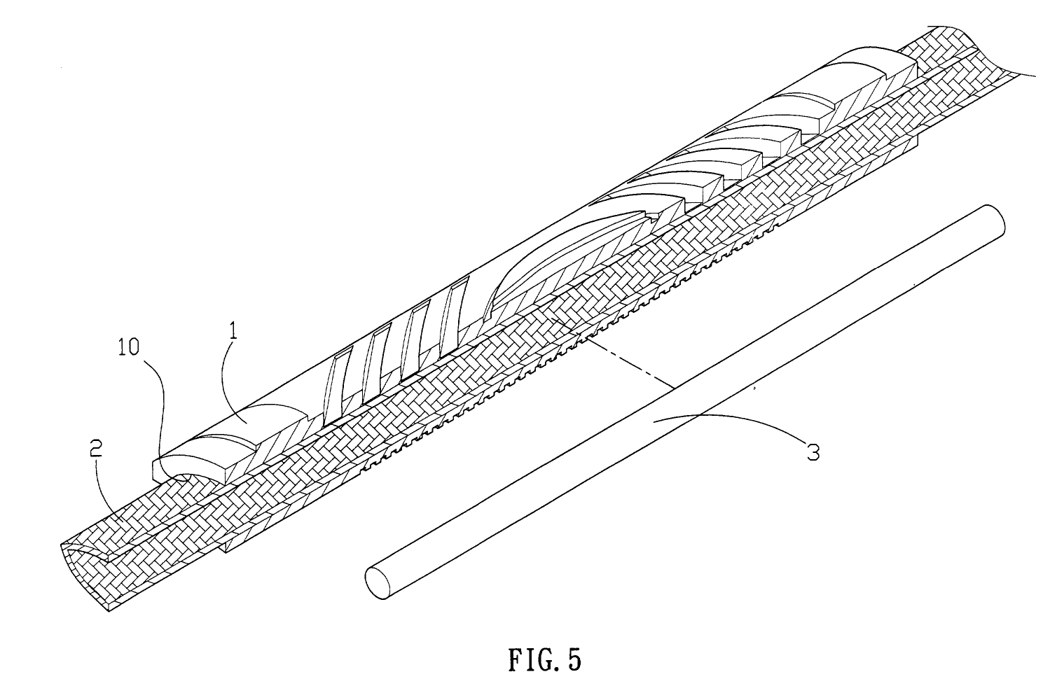

FIG. 5 shows that the inner member 3 can be a flexible cable which is made of flexible metal.

While we have shown and described the embodiment in accordance with the present invention, it should be clear to those skilled in the art that further embodiments may be made without departing from the scope of the present invention.

What is claimed is:

1. A handle for a suitcase, comprising:
an inner member comprising a plurality of units which are rotatably connected with each other in an axial direction thereof;
a flexible fabric wrapping the inner member and two ends of the flexible fabric adapted to be fixed to the suitcase, and
an outer casing having a passage defined longitudinally therethrough and the inner member and the flexible fabric being received in the passage.

2. The handle as claimed in claim 1, wherein each unit includes a tail and a head, a recess defined in the tail and opening to a distal end of the tail in which the head of next unit is rotatably engaged.

3. The handle as claimed in claim 2 further comprising a neck connected between the head and the tail.

4. The handle as claimed in claim 2, wherein the tail is larger than the head.

5. The handle as claimed in claim 1, wherein each unit has two holes respectively and radially defined through two ends thereof and a pin extends through two aligned holes of two respective overlapped ends of two adjacent units.

6. A handle for a suitcase, comprising:
an inner member being a flexible cable;
a flexible fabric wrapping the inner member and two ends of the flexible fabric adapted to be fixed to the suitcase, and
an outer casing having a passage defined longitudinally therethrough and the inner member and the flexible fabric being received in the passage.
